(19) United States
(12) Patent Application Publication
(10) Pub. No.: US 2012/0020664 A1
(43) Pub. Date: Jan. 26, 2012

(54) WAVELENGTH SELECTIVE LIGHT CROSS CONNECT DEVICE

(76) Inventors: Yasuki SAKURAI, Aichi (JP); Taihei Miyakoshi, Aichi (JP)

(21) Appl. No.: 12/896,991

(22) Filed: Oct. 4, 2010

(30) Foreign Application Priority Data
Jul. 21, 2010 (JP) 2010-164128

(51) Int. Cl. H04J 14/00

(52) U.S. Cl. 398/50

(57) ABSTRACT

A wavelength selective light cross connect device 1A is configured of a route selector 10A including route selection elements 11-1 to 11-N, wavelength selector 20A, route selector 40A including route selection elements 41-1 to 41-M and controller 50A. The route selection elements 11-1 to 11-N select routes for WDM signals of N channels inputted to input routes Rin1 to RinN, and directs the WDM signals to the wavelength selector 20A. The wavelength selector 20A performs a selection operation to (N×M) WDM signals according to their wavelength, and outputs the signals. Wavelength selection elements 40-1 to 40-M receives different outputs obtained from the respective route selection elements via the wavelength selector 20A, selects routes and outputs the signals from output routes Rout1 to RoutM.

### BACKGROUND OF THE INVENTION

1. Field of the Invention

The present invention relates to a wavelength selective light cross connect device having a plurality of input and output routes provided at an optical node corresponding to a branch point in an optical network in an optical telecommunications field.

2. Discussion of the Related Art

A wavelength division multiplexing optical communication technique is applied to a high-speed and large-capacity optical network that supports today's advanced information-telecommunication society. A ROADM (Reconfigurable Optical Add Drop Multiplexer) device having a reconfigurable add-drop function has been introduced to the optical node corresponding to the branch point in the optical network. To realize the ROADM device, a wavelength selective switch (also referred to as WSS) for switching a desired wavelength to a desired direction has received attention. At present, the wavelength selective switch having the number of input routes N of 1 and the number of output routes M of 2 or more is used. However, to achieve a large-capacity network in future, the node performance is required to improve, and there is a demand for a multiple input/output wavelength selective cross connect device in which both the number of input routes and the number of output routes are plural.

According to a conventional method, as disclosed in US2008/0138068, it is possible to realize a multiple input/output wavelength selective cross connect device including N number of 1×M wavelength selective switches connected to input routes and M number of N×1 wavelength selective switches each receiving outputs of the 1×M wavelength selective switches. FIG. 1 is a diagram showing an example of the multiple input/output wavelength selective switch device in which the number of input routes N is four and the number of output routes M is six. In this figure, the multiple input/output wavelength selective switch device has four 1×6 wavelength selective switches (WSS) 110-1 to 110-4 connected to input routes Rin1 to Rin4. Outputs of each of the wavelength selective switches 110-1 to 110-4 are inputted to each of six 4×1 wavelength selective switches 120-1 to 120-6, and selected outputs are outputted from output routes Rout1 to Rout6. Thus, the multiple input/output wavelength selective cross connect device can be realized.

However, because the wavelength selective switch has a complicated structure, a device area is so large that it cannot be easily mounted on an optical mount board, resulting in an increase in device price. In the configuration shown in this figure, since (N+M) wavelength selective switches are used, disadvantageously, a failure rate is high and transmission reliability is low.

Thus, to realize compact multiple input/output wavelength cross connect switch with a small number of parts, US2008/0138068 proposes use of a plurality of 2×N wavelength selective switches utilizing inclination of an MEMS (Micro Electric Mechanical System) minute mirror.

### SUMMARY OF THE INVENTION

However, according to this approach, the number of input routes N must be equal to the number of output routes M. Also in this case, because 2N wavelength selective switches are used, as compared to the case where one wavelength selective switch is used, a failure rate is as high as 2N times and transmission reliability is lowered. Further, there is a disadvantage that the switches are essentially vulnerable to external perturbations such as vibrations and shocks since a mirror such as MEMS is mechanically driven.

In consideration of such conventional problems, the present invention intends to achieve a compact mounting area and improve the transmission reliability without using a conventional wavelength selective switch and movable parts such as MEMS.

To solve the problems, a wavelength selective light cross connect device of the present invention for inputting wavelength division multiplexing optical signals (hereinafter referred to as WDM signals) of first to Nth channels, the signals each having wavelengths λ₁ to λ_{L} (L is a natural number of 2 or more), to N input routes (N is a natural number of 2 or more) respectively, selecting signals of desired plural wavelength from each of the inputted WDM signals and outputting the selected signals from M output routes (M is t a natural number of 2 or more) comprises: a first group of N route selection elements each having one input terminal and M output terminals, the first group of route selection elements selecting at last one route for the WDM signal inputted to each input route and outputting the signal from the M output terminal; a wavelength selector for receiving N×M outputs of said N route selection elements, selecting at last one optical signal of desired wavelengths from each of the inputted WDM signals and outputting the WDM signals of the same number as that of the inputted WDM signals; and a second group of M route selection elements each having N input terminals and one output terminal, the second group of route selection elements selecting a route for the M WDM signals inputted to each input route and outputting the signal from the one output terminal.

In the wavelength selective light cross connect device, said first group of route selection elements may be N splitters for branching the inputted WDM signal into M outputs, and said second group of route selection elements may be M couplers for receiving one of outputs of each of said first group of route selection elements, the outputs passing through said wavelength selector, and synthesizing the outputs into one output.

In the wavelength selective light cross connect device, said first group of route selection elements may be N (1×M) optical switches for selectively directing the inputted WDM signal to one of M outputs, and said second group of route selection elements may be M couplers for receiving one of outputs of each of said first group of route selection elements, the outputs passing through said wavelength selector, and synthesizing the outputs into one output.

In the wavelength selective light cross connect device, said first group of route selection elements may be N splitters for branching the inputted WDM signal into M outputs, and said second group of route selection elements may be M (N×1) optical switches for receiving one of outputs of each of said first group of route selection elements, the outputs passing through said wavelength selector, and selecting one output.

In the wavelength selective light cross connect device, said first group of route selection elements may be N (1×M) optical switches for selectively directing the inputted WDM signal to one of M outputs, and said second group of route selection elements may be M (N×1) optical switches for receiving one of outputs of each of said first group of route selection elements, the outputs passing through said wavelength selector, and selecting one output.

In the wavelength selective light cross connect device, each of said first group of route selection elements may be a waveguide element for selecting at least one output by a branch cascade-connected on an optical waveguide, and each of said second group of route selection elements may be a waveguide element for selecting at least one input by the branch cascade-connected on the optical waveguide.

In the wavelength selective light cross connect device, said first group of route selection elements may be N splitters for branching the inputted WDM signal into M outputs, said wavelength selector may output at least a part of outputs of inputs obtained from each of said first group of route selection elements after a wavelength selective operation as a drop, and said second group of route selection elements may be M couplers, at least a part of inputs of said second group of route selection elements being an add input and remaining inputs being outputs of each of said first group of route selection elements, the outputs passing through said wavelength selector, the M couplers synthesizing these inputs into one output.

In the wavelength selective light cross connect device, said wavelength selector may include: a first dispersion element arranged along a direction of a y axis, the element spatially dispersing first to (N×M)^{th} WDM signal light beams having a plurality of wavelengths according to their wavelengths; a first light condensing element for condensing the WDM light beam of each channel dispersed by said first dispersion element into parallel light beam; a wavelength selection element having a multiplicity of pixels arranged in a direction of an x axis according to wavelength, the pixels being placed so as to receive N×M WDM light beams arranged at different positions with respect to the y axis so as to be developed over an xy plane and being arranged in a lattice pattern on the xy plane, and selecting light in desired wavelength bands with respect to desired WDM signals by changing transmission characteristics of each of the pixels arranged in a two-dimensional fashion; a wavelength selection element driving unit for driving electrodes arranged in xy directions of said wavelength selection element to control light transmission characteristics of a pixel lying at a predetermined position in the x-axis direction as well as in the y-axis direction; a second light condensing element for condensing light beams of different wavelengths transmitted through said wavelength selection element; and a second wavelength dispersion element for synthesizing dispersed light beams condensed by said second light condensing element.

In the wavelength selective light cross connect device, said wavelength selection element may be an LCOS element.

In the wavelength selective light cross connect device, said wavelength selection element may be a two-dimensional liquid crystal array element.

In the multiple input/output wavelength selective switch device, said wavelength selector may include: a plurality of entrance/exit section arranged along a direction of a y axis, the entrance/exit section receiving first to (N×Myth WDM signal light beams, each of which is composed of multiple-wavelength light, and exiting optical signals of selected wavelengths on a channel to channel basis; a wavelength dispersion element for spatially dispersing the (N×M) WDM signal light beams obtained from said entrance/exit section according to their wavelengths; a light condensing element for condensing the WDM signal light beams of different channels dispersed by said wavelength dispersion element on a two-dimensional xy plane; a wavelength selection element having a multiplicity of pixels arranged in a direction of an x axis according to wavelength, the pixels being placed so as to receive (N×M) WDM light beams arranged at different positions with respect to the y axis so as to be developed over the xy plane and being arranged in a lattice pattern on the xy plane, and the wavelength selection element selecting light in desired wavelength bands with respect to desired WDM signals by changing reflection characteristics of each of the pixels arranged in a two-dimensional fashion; and a wavelength selection element driving unit for driving an electrode of each of the pixels arranged in xy directions of said wavelength selection element to control light reflection characteristics of a pixel lying at a predetermined position in the x-axis direction as well as in the y-axis direction.

In the wavelength selective light cross connect device, said wavelength selector is a wavelength blocker.

As described above in detail, according to the present invention, since the wavelength cross connect device is configured as a unit and a plurality of wavelength selective switches are not used, the switch becomes compact, resulting in a small mounting area and reliability is improved. Further, it is possible to provide a multiple input/output wavelength selective cross connect device that is hard to be affected by external perturbations such as vibrations and shocks without using the movable parts such as MEMS.

### BRIEF DESCRIPTION OF THE DRAWINGS

FIG. 1 is a block diagram showing an example of a conventional wavelength selective light cross connect device having four input routes and six output routes;

FIG. 2 is a block diagram showing an example of a wavelength selective light cross connect device in accordance with a first embodiment of the present invention;

FIG. 3 is a block diagram showing an example of a wavelength selective light cross connect device in accordance with a second embodiment of the present invention;

FIG. 4A is a diagram showing an optical arrangement of a wavelength selector in accordance with the second embodiment of the present invention as seen in an x-axis direction;

FIG. 4B is a diagram showing the optical arrangement of the wavelength selector in accordance with the second embodiment of the present invention as seen in a y-axis direction,

FIG. 5 is a diagram showing an LCOS element employed in the wavelength selector in accordance with this embodiment;

FIG. 6A is a diagram showing an example of a modulation mode for the LCOS element employed in this embodiment;

FIG. 6B is a diagram showing another example of the modulation mode for the LCOS element employed in this embodiment;

FIG. 7A to FIG. 7D are diagrams showing how the LCOS element is to be driven;

FIGS. 8A to 8D are diagrams showing selection characteristics of a filter corresponding to driving conditions of the LCOS element;

FIG. 9 is a block diagram showing an example of a wavelength selective light cross connect device in accordance with a third embodiment of the present invention;

FIG. 10 is a block diagram showing an example of a wavelength selective light cross connect device in accordance with a fourth embodiment of the present invention;

FIG. 11 is a block diagram showing an example of a wavelength selective light cross connect device in accordance with the fifth embodiment of the present invention;

FIG. 12 is a table showing functions of the wavelength selective light cross connect devices in accordance with second to fifth embodiments;

FIG. 13 is a block diagram showing an example of a wavelength selective light cross connect device in accordance with a sixth embodiment of the present invention;

FIG. 14 is a block diagram showing a wavelength selective light cross connect device having an add drop function in accordance with a seventh embodiment of the present invention;

FIG. 15A is a diagram showing an optical arrangement of a reflection-type wavelength selector in accordance with an eighth embodiment of the present invention as seen in the x-axis direction;

FIG. 15B is a diagram showing the optical arrangement of the reflection-type wavelength selector in accordance with the eighth embodiment of the present invention as seen in the y-axis direction;

FIG. 16A is a diagram showing an example of a modulation mode for the LCOS element employed in the eighth embodiment of the present invention;

FIG. 16B is a diagram showing another example of the modulation mode for the LCOS element employed in the eighth embodiment of the present invention;

FIG. 17 is a diagram showing another example of a wavelength selection element of the present invention; and

FIG. 18 is a diagram showing still another example of a wavelength selector of the present invention.

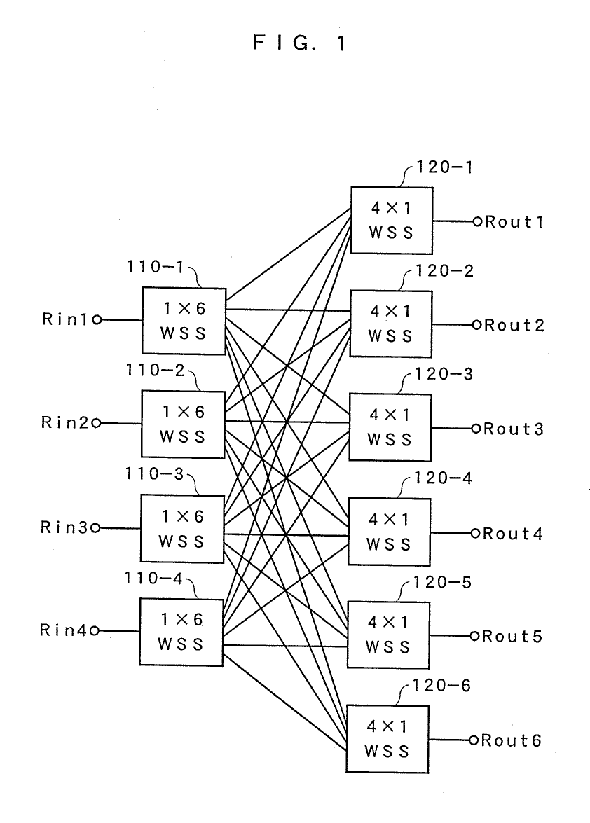

### DESCRIPTION OF THE PREFERRED EMBODIMENTS

### First Embodiment

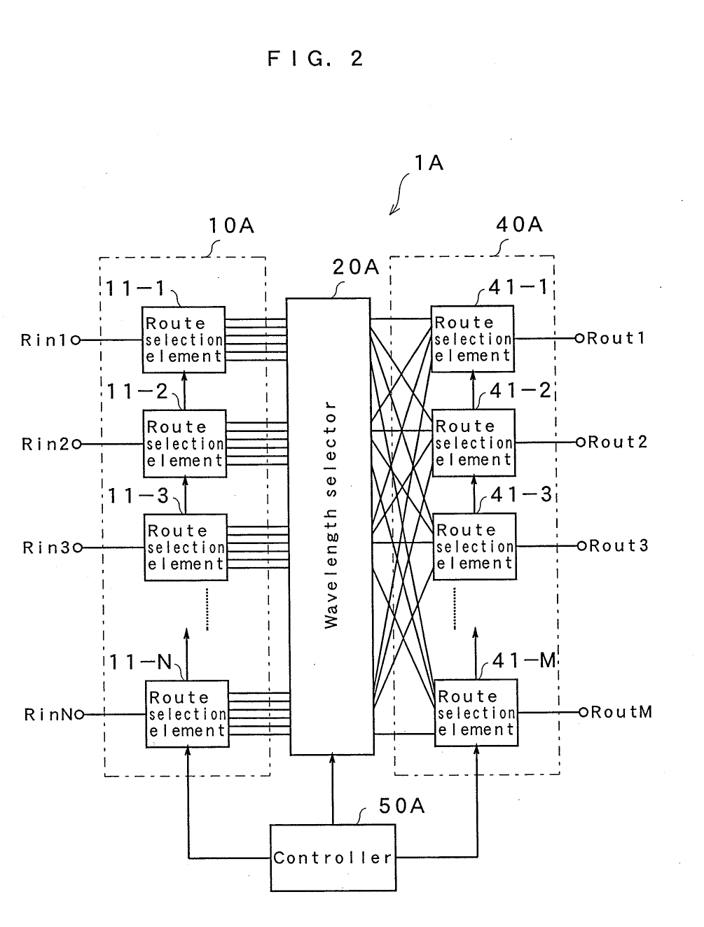

FIG. 2 is a diagram showing a configuration of a wavelength selective light cross connect device 1A according to a basic configuration of the present invention.

This cross connect device 1A has N (N is a natural number of 2 or more) input routes Rin1 to RinN and M (M is a natural number of 2 or more) output routes Rout1 to RoutM. The cross connect device 1A is configured of a route selector 10A, wavelength selector 20A, route selector 40A and controller 50A. Here, it is assumed that an optical signal of a first channel inputted to the input route Rin1 is a wavelength division multiplexing optical signal (hereinafter referred to as WDM signal) obtained by multiplexing optical signals of wavelengths λ₁₁ to λ_{L1} (L is a natural number of 2 or more). It is assumed that an optical signal of a second channel inputted to the input route Rin2 is also a WDM signal obtained by multiplexing optical signals of wavelengths λ₁₂ to λ_{L2}. Generally describing, it is assumed that a WDM signal of k^{th} channel (k=1 to N) inputted to the input route Rin(k) is a WDM signal obtained by multiplexing optical signals of wavelengths λ₁ₖ to λ_{Lk}. Here, the same first suffix (1 to L) represents the same wavelength and the second suffix (1 to N) represents the channel. The WDM signals of N channels are inputted to the route selector 10A directly or through optical fibers.

The route selector 10A has a first group of N route selection elements 11-1 to 11-N connected to the respective input routes. Each of the route selection elements is an element capable of selectively outputting the WDM signal inputted to the input route to M output terminals. “Route selection” in the route selector 10A includes selection of at least one route of the output terminals as well as selection of all routes of the output terminals.

The wavelength selector 20A has N×M input terminals and N×M output terminals, separates the WDM signal inputted to each of the input terminals according to their wavelengths, performs a filtering operation the light beam of each wavelength, synthesizes the light and outputs the synthesized light as the WDM signal. The wavelength selector 20A performs the filtering operation the i^{th} (i=1 to N×M) WDM signal and outputs the filtered signal as the i^{th} WDM signal. In this filtering operation, typically, light of a particular wavelength is blocked or transmitted. In addition, an equalizer function to keep a level of light to be transmitted uniform may be provided.

The route selector 40A connected to the output terminals of the wavelength selector 20A has a second group of M route selection elements 41-1 to 41-M. Each of the route selection elements is an element capable of selecting WDM signals among the WDM signals inputted to N input terminals and desirably outputting one WDM signal to one output terminal. The route selection element 41-1 receives first outputs of the route selection elements 11-1 to 11-N, which pass through the wavelength selector 20A, selects one of them and outputs the selected one as one WDM signal to the output route Rout1. In this case, one wavelength band from the WDM signal of one channel is used. The route selection element 41-2 receives second outputs of the route selection elements 11-1 to 11-N, which pass through the wavelength selector 20A, selects one of them and outputs the selected one as one WDM signal to the output route Rout2. In this case, one wavelength band from the WDM signal of one channel is used. The same applies to the other route selection elements. Generally describing, the route selection element 41-P (P=1 to M) receives pth outputs of the route selection elements 11-1 to 11-N, which pass through the wavelength selector 20A, selects one of them and outputs the selected one as one WDM signal to an output route RoutP. Here, “route selection” in the route selector 40A includes selection of at least one of the input routes as well as selection of all of the input routes.

Next, the controller 50A controls switching states of the N route selection elements 11-1 to 11-N, wavelength selector 20A and M route selection elements 41-1 to 41-M. The controller 50A controls a level of each of light beams having different wavelengths of the WDM signals in the wavelength selector 20 according to their wavelengths.

The cross connect device of the present invention can select a plurality of desired wavelengths for the WDM signal inputted to each of the input routes Rin1 to RinN and output the WDM signals of desired wavelengths to the desired output route Rout1 to RoutM by use of the route selectors 10A, 40A and wavelength selector 20A.

### Second Embodiment

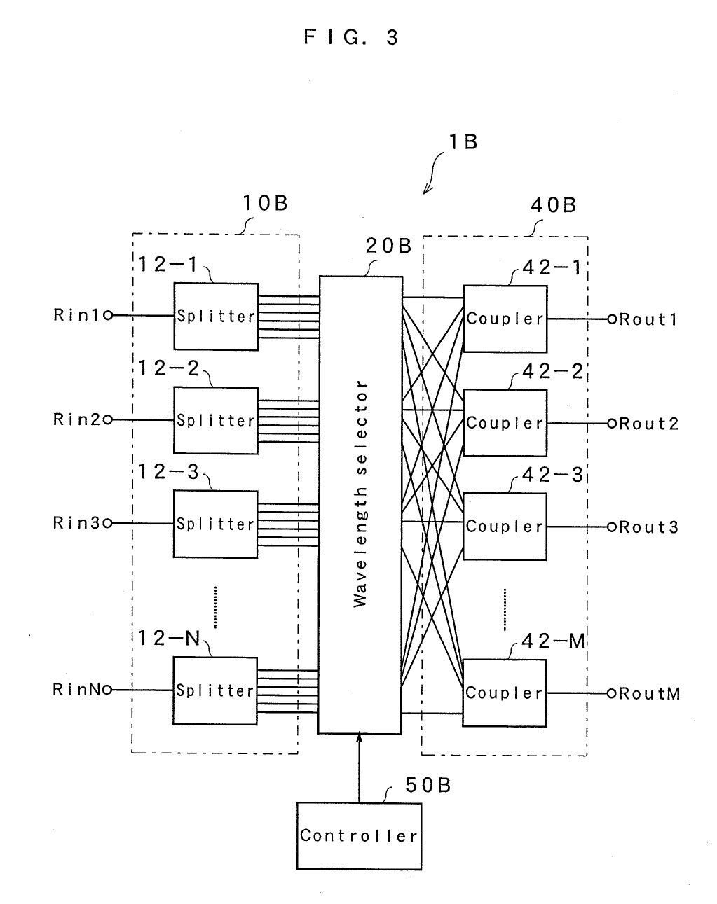

Next, more detailed embodiment of the present invention will be described. FIG. 3 is a diagram showing a configuration of a wavelength selective light cross connect device 1B in accordance with a second embodiment of the present invention. The cross connect device 1B in accordance with this embodiment is configured of a route selector 10B, wavelength selector 20B, route selector 40B and controller 50B. A first group of N route selection elements in the route selector 10B is formed of N splitters 12-1 to 12-N that each branch an input into the number of output routes. The splitter 12-1 branches a WDM signal of a first channel inputted from the input route Rin1 into M outputs and outputs each output to the wavelength selector 20B. Similarly, the splitter 12-2 branches a WDM signal of a second channel inputted from the input route Ring into M outputs, and outputs each output to the wavelength selector 20B. The same applies to the other splitters 12-3 to 12-N. Whereby, M WDM signals of each of all WDM signals of N channels inputted to the input routes can be inputted to the wavelength selector 20B.

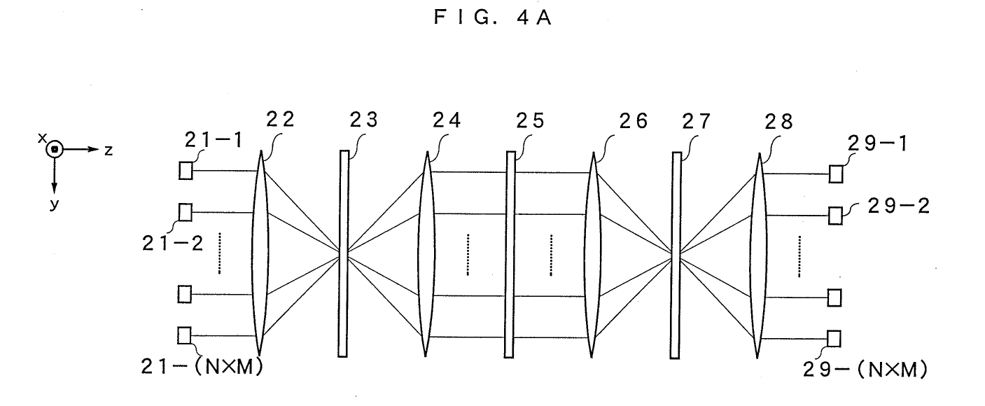

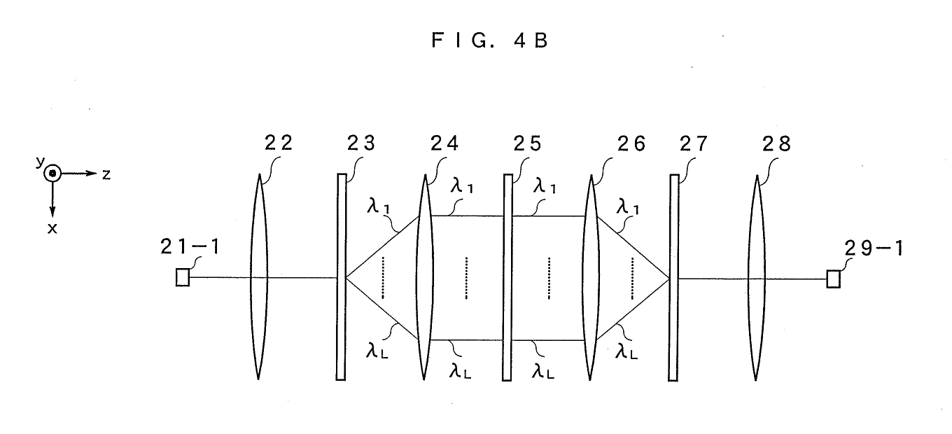

Next, a configuration of the wavelength selector 20B in accordance with this embodiment will be described in detail. The wavelength selector 20B has N×M input terminals and N×M output terminals. In FIG. 4, provided that numbers of incoming light beams are first to (N×M)^{th}, the incoming light beams entered to the wavelength selector 20B are N×M WDM signals. The WDM signals are injected to collimator lenses 21-1 to 21-(N×M), respectively, and are fed to a lens 22 as parallel light beams. The lens 22 condenses the WDM light beams to a point in a y-axis direction, and a first wavelength dispersion element 23 is provided at a light-condensing position. The first wavelength dispersion element 23 can be configured of a diffraction grating, prism or combination of a diffraction grating and prism. As shown in FIG. 4B, the wavelength dispersion element 23 emits light beams in different directions on an xz plane according to their wavelengths. All of these light beams are incident on a lens 24. The lens 24 is a first light condensing element for condensing light beams dispersed on an xy plane in a direction parallel to a z axis. A wavelength selection element 25 is disposed perpendicularly to an optical axis of the lens 24. The wavelength selection element 25 transmits incoming light in a selective manner based on the output from the controller 50B, which will be described in detail later. The light transmitted through the wavelength selection element 25 is incident on a lens 26. A pair of the lens 24 and first wavelength dispersion element 23 and a pair of the lens 26 and second wavelength dispersion element 27 are arranged in plane-symmetrical relation with respect to the xy plane at the center of the wavelength selection element 25. The lens 26 is a second light condensing element for condensing parallel light beams on the xz plane. A second wavelength dispersion element 27 synthesizes light beams having different wavelength components, which come from different directions, and emits the light beams in a synthesized state. The light synthesized by the second wavelength dispersion element 27 is converted into M WDM light beams that are discrete in the y-axis direction by a lens 28. The WDM light beams each are parallel to a z axis.

The WDM light beams are outputted to couplers 42-1 to 42-(N×M) through collimator lenses 29-1 to 29-(N×M).

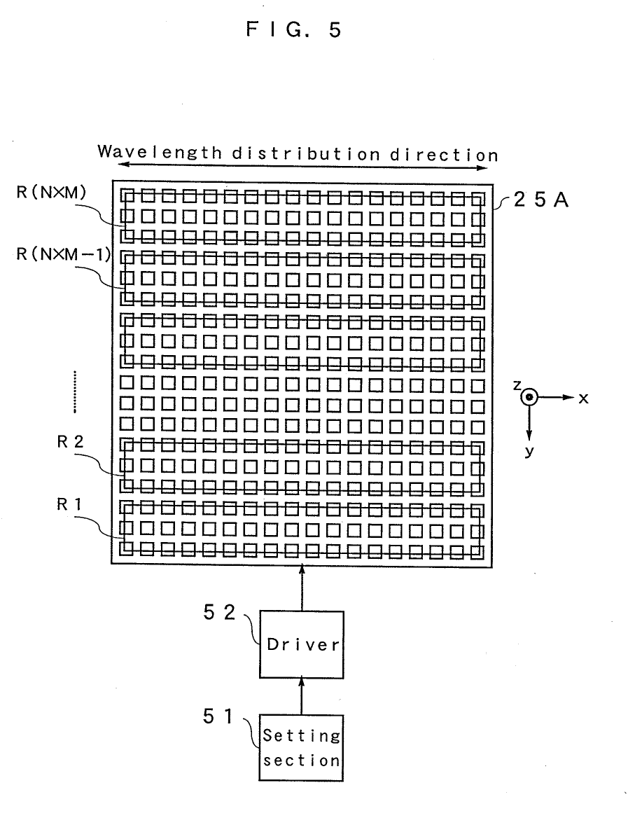

Next, the wavelength selection element 25 used in this embodiment will be described. As shown in FIG. 5, the wavelength selection element 25 is an element having a structure composed of pixels two-dimensionally arranged in a T×Q dot matrix. Further, a setting section 51 in the controller 50B is connected to the wavelength selection element 25 via a driver 52. The setting section 51 determines which pixel is used to transmit light on the xy plane according to a selected wavelength of a selected channel, and the driver 52 is a wavelength selection element driving unit for controlling light transmission characteristics of a pixel at a predetermined position.

When the first to (N×M)^{th} WDM light beams is dispersed in the y-axis direction and also dispersed in the x-axis direction according to their wavelengths so as to be incident on the wavelength selection element 25 as N×M parallel light beams in a strip-like form, incident regions R1 to R (N×M) of the first to N×M^{th} WDM light beams each are assumed to be a rectangular region shown in FIG. 5. That is, the light beams applied to the incident regions R1 to R (N×M) are the WDM light beams corresponding to the first to (N×M^{th} channels developed over the xy plane according to input number i to the wavelength selection element 25 (i=1 to (N×M)) and wavelength band λj (j=1 to L). In the wavelength selector 20B, light having a desired wavelength can be selected by selecting corresponding pixels for transmission.

The wavelength selection element 25 can be practically realized by using an LCOS (Liquid Crystal On Silicon)-based LC element. An LCOS element 25A has a built-in liquid crystal modulation driver 52 located at the back of each pixel. Accordingly, the number of pixels can be increased and thus, for example, the LCOS element 25A can be formed of a multiplicity of pixels arranged in a 1000×1000 lattice pattern. In the LCOS element 25A, since light beams are incident separately at different positions according to channel and wavelength, by bringing a pixel corresponding to the incident position of a target light beam into a transmissive state, it is possible to select the optical signal thereof.

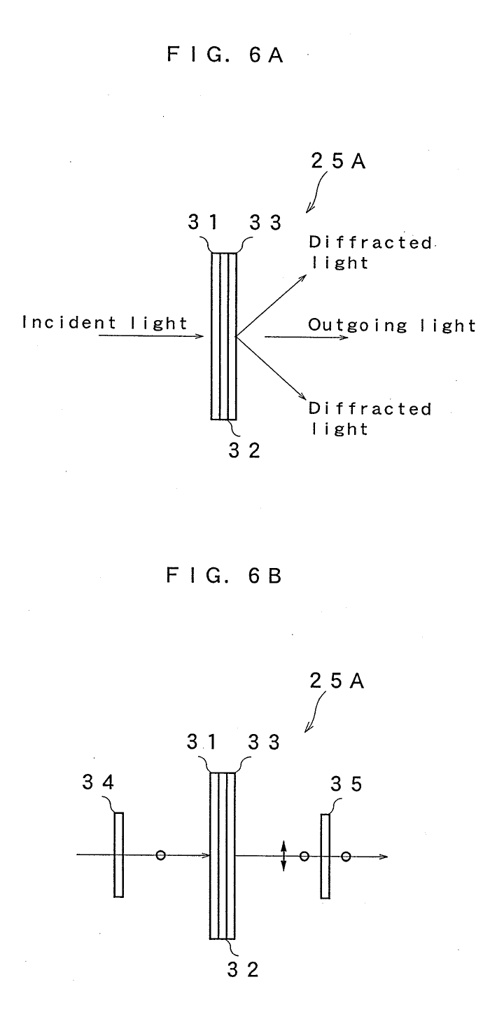

Now, as one of modulation modes applicable to the LCOS element 25A, a phase modulation mode will be explained. FIG. 6A is a schematic diagram showing the LCOS element. The LCOS element is composed of a transparent electrode 31, a liquid crystal 32, and a transparent electrode 33 that are arranged in the order named, from the plane of incidence's side, along the z-axis direction in a layered structure. In the LCOS element 25A, since a plurality of pixels are assigned to constitute a single wavelength band of one WDM single, it is possible to impart unevenness to a refractive index profile with respect to a plurality of pixels and thereby develop a diffraction phenomenon. Accordingly, by applying a voltage between the transparent electrode 31 and the transparent electrode 33, the angles of diffraction of different frequency components can be controlled independently, so that input light with a specific wavelength can be caused to travel in a straight line in the z-axis direction and eventually pass through the element, and light of another wavelength components can be diffracted as unnecessary light in a direction different from the z-axis direction. Therefore, by controlling a voltage to be applied to each pixel, necessary pixels can be brought into a transmissive state without causing diffraction.

Next, as another modulation mode applicable to the LCOS element, an intensity modulation mode will be explained. FIG. 6B is a diagram showing a wavelength selection method based on the intensity modulation mode. A polarizer 34 is placed on the plane of incidence for incoming light. The polarizer 34 brings incoming light into a specific polarized state as indicated by a circle in the diagram, and the polarized light is incident on the LCOS element 25A. Also in this case, the LCOS element is composed of a transparent electrode 31, a liquid crystal 32, and a transparent electrode 33. A polarizer 35 is placed on the optical axis of the outgoing light transmitted through the LCOS element. The polarizer 35 allows the exit of only light in a specific polarized state as indicated by the circle in the diagram. With the incidence of light on the LCOS element, a difference in index of double refraction in the liquid crystal between the electrodes can be controlled on the basis of the conditions of voltage application. Accordingly, the polarization state of transmitted light can be varied by adjusting to-be-applied voltages independently. Then, it is determined whether the plane of polarization is rotated or retained at the time of voltage control in accordance with orientational ordering among liquid-crystal molecular components. For example, assuming that the plane of polarization is retained in the absence of voltage application, then the light indicated by the circle is simply transmitted. On the other hand, in the presence of voltage application, the plane of polarization is rotated to effect transmission, and the transmitted light is shielded by the polarizer 35. Therefore the selection of incoming light can be achieved by controlling voltages to be applied to the pixels. The selection of a plurality of given wavelength bands of a plurality of given WDM signal light beams can be made by bringing a given number of corresponding pixels into a transmissive state.

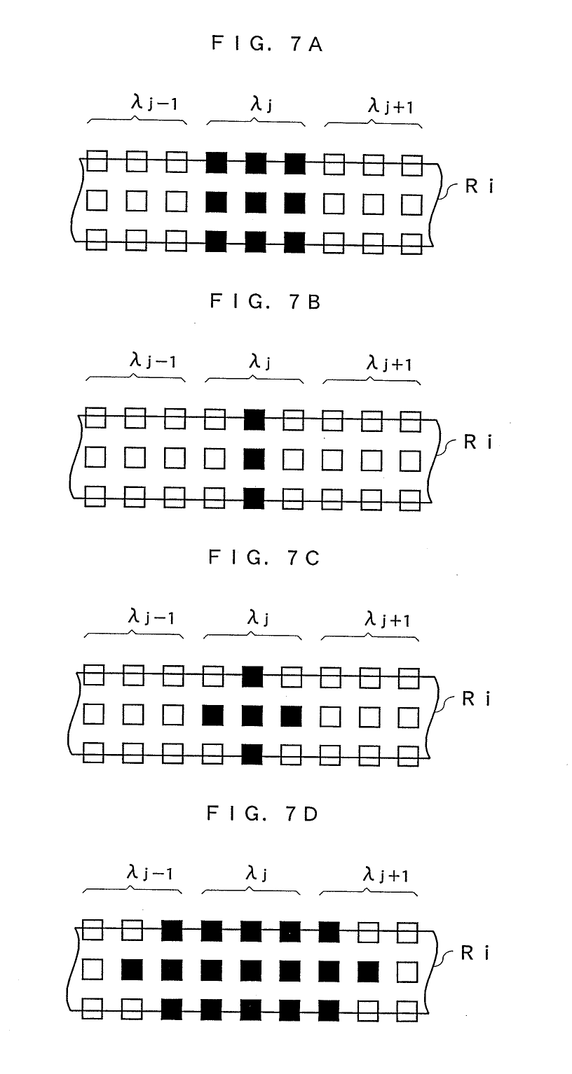

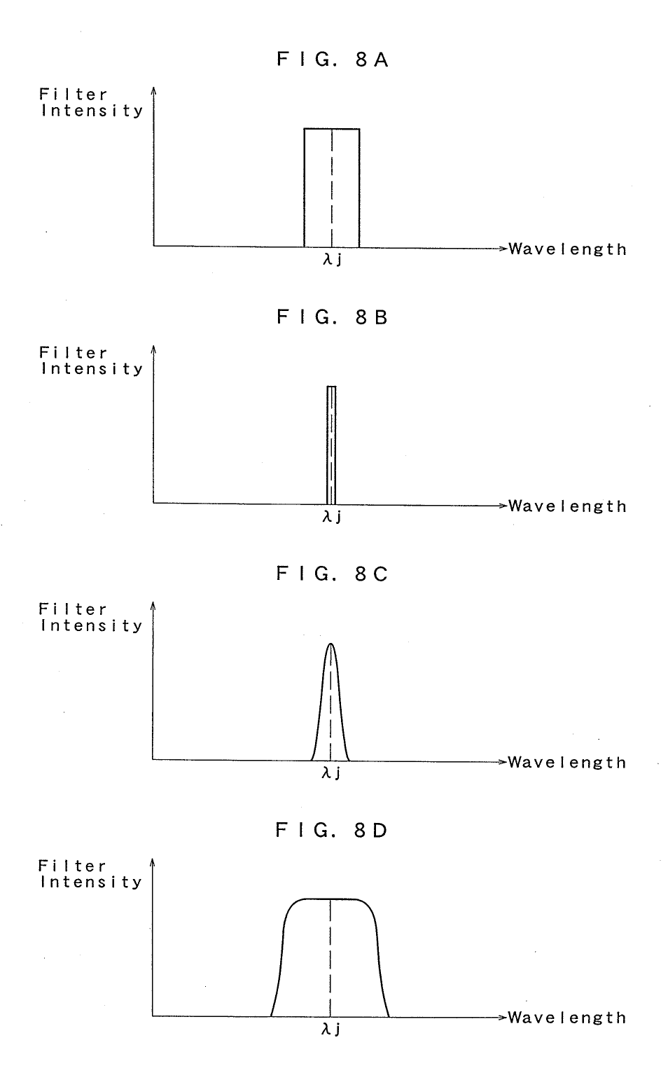

The LCOS element 25A employed in the second embodiment has, for example, a 3(M+N)×3L pixel arrangement with respect to WDM signals of (M×N) each having L wavelength bands ranging from λ₁ to λ_{L}. In this way, when it is desired to select a specific wavelength of a WDM signal corresponding to a specific channel, for example, a signal in a wavelength band λⱼ of WDM light corresponding to an i-th input as shown in FIG. 7A, by bringing 9 dots of pixels, namely 3i to 3i+2 and 3j to 3j+2, into a transmissive state, the wavelength of the number can be selected. In FIG. 7A, a pixel to be brought into a transmissive state is represented as a black box. When light is incident on a pixel in a transmissive state of the LCOS element 25A, then the incident light is simply transmitted through the output side. Meanwhile, light with a non-target wavelength incident on an unselected pixel is diffracted or shielded and is therefore no longer output. Thus, in the case of selecting 9 pixels corresponding to a specific wavelength band, as shown in FIG. 8A, as a filter configuration, there is obtained a flat-top type spectral waveform pattern characterized by inclusion of signal spectral components and low crosstalk between adjacent channels.

Moreover, in the LCOS element 25A, the filter configuration can be determined freely by adjusting the number of pixels to be brought into an ON state as well as an OFF state. That is, in FIG. 7A, by selecting one of the pixels placed in a 3×3 arrangement corresponding to a specific wavelength band of a specific inout number, it is possible to keep the filter at a low level in respect of its transmittance. Further, by selecting part of the 9 pixels covering the wavelength band λⱼ of the inout number i in the LCOS element 25A, it is possible to obtain a desired wavelength. In this way, when light is incident on the LCOS element 25A, a passband width corresponding to the width of the reflection region can be obtained. That is, as shown in FIG. 7B, out of the 9 pixels covering the wavelength band λⱼ of the input number i, centrally located 3 pixels are brought into a transmissive state. This makes it possible to attain narrow-range selection characteristics as shown in FIG. 8B for selecting wavelengths forming central portions of the wavelength band λⱼ.

Moreover, as shown in FIG. 7C, pixels adjacent to the central 3 pixels are also brought into a transmissive state at the same time. This makes it possible to attain near-Gaussian selection characteristics as shown in FIG. 8C in which the passband is slightly widened.

Further, as shown in FIG. 7D, in addition to the 9 pixels covering the wavelength band λⱼ, part of the pixels adjacent thereto is also brought into a transmissive state.

This makes it possible to render the passband even wider as shown in FIG. 8D.

Next, the route selector 40B is provided on an output side of the wavelength selector 20B. A second group of route selection elements that form the route selector 40B is composed of M couplers 42-1 to 42-M. The coupler 42-1 receives first outputs of the splitters 12-1 to 12-N, which pass through the wavelength selector 20B, synthesizes the outputs into one WDM signal and outputs the synthesized WDM signal to the output route Rout1. In this case, it is assumed that one wavelength band is previously selected at the wavelength selector 20B. The coupler 42-2 receives second outputs of the splitters 12-1 to 12-N, which pass through the wavelength selector 20B, synthesizes the outputs into one WDM signal and outputs the synthesized WDM signal to the output route Rout2. In this case, it is assumed that one wavelength band is previously selected at the wavelength selector 20B. The same applies to the other couplers. Generally describing, a coupler 42-P (P=1 to M) receives P^{th} outputs of the splitters 12-1 to 12-N, which pass through the wavelength selector 20B, synthesizes them into one WDM signal and outputs the synthesized signal to the output route RoutP. The couplers and splitters are identical components and are reversed in input/output.

In this embodiment, since the plurality of WDM signals of the same channel are inputted to the wavelength selector 20B, a multi-cast function can be performed. The multi-cast function is a function to output the plurality of WDM signals of the same channel from the plurality of output routes. Since the number of input routes capable of selecting one output route is N, signals of different wavelength bands from the plurality of input routes can be combined and outputted as one output WDM signal.

In this embodiment, the optical cross connect device 1B comprises N splitters and M couplers. These components are very simple, low level functional parts as compared to a wavelength selective switch, and thereby it is possible to lower a failure rate, achieve a compact mounting area and improve transmission reliability.

Here, N splitters 11-1 to 11-N and M couplers 42-1 to 42-M of the device can be formed on a same optical flat wave guide, resulting in making the cross connect device 1B compact.

Further, the wavelength selector 20B of the present invention is configured such that it is hard to be affected by external perturbations such as vibrations and shocks without using the movable parts.

The transmittance can be continuously varied by adjusting the level of a voltage to be applied to each of the pixels of the LCOS element 25A. Accordingly, by controlling pixels subjected to voltage application and voltage level, various filter characteristics can be attained.

Further, an equalization function can be achieved through monitoring output level of each wavelength of each WDM signal so as to keep a level of transmitted light uniform.

It is noted that, although the pixels placed in the 3×3 arrangement are assigned to each wavelength band of a single channel of a WDM signal in the present embodiment, by increasing the number of pixels to be assigned or by exercising voltage level control on a pixel-by-pixel basis, it is possible to control filter characteristics more precisely.

### Third Embodiment

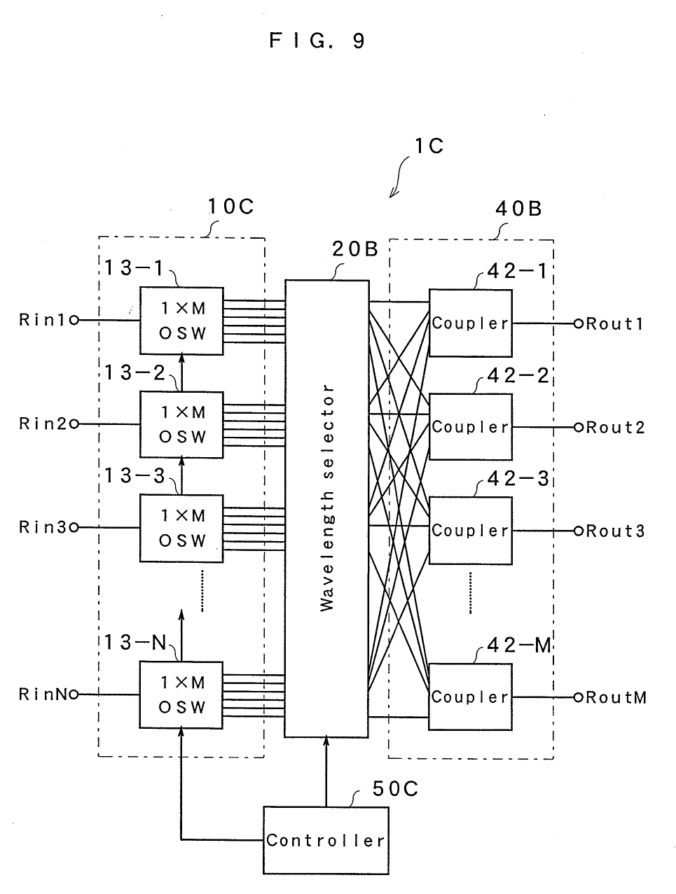

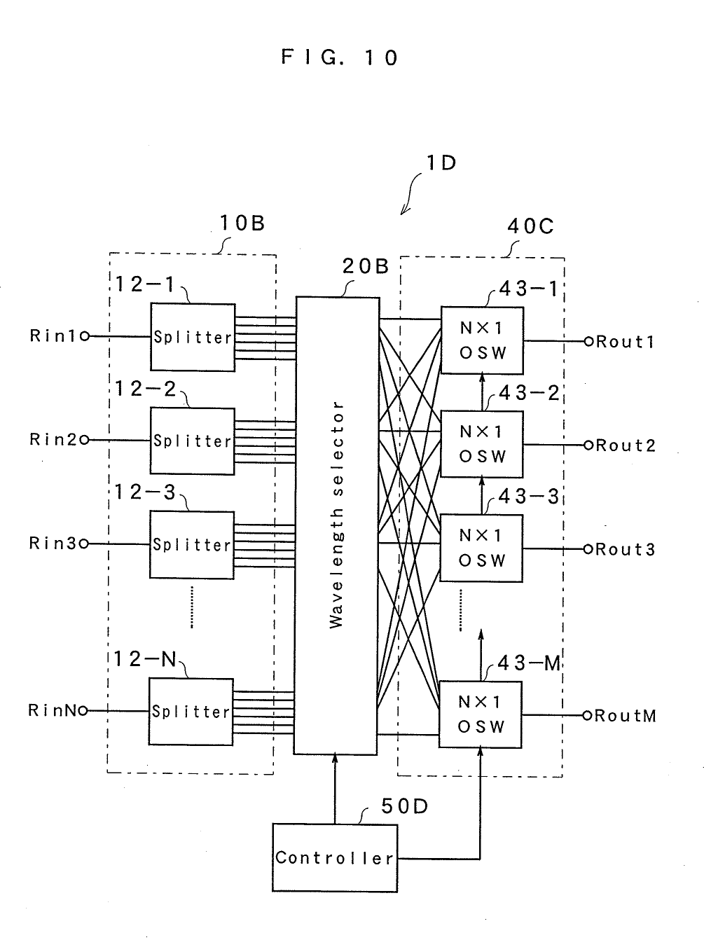

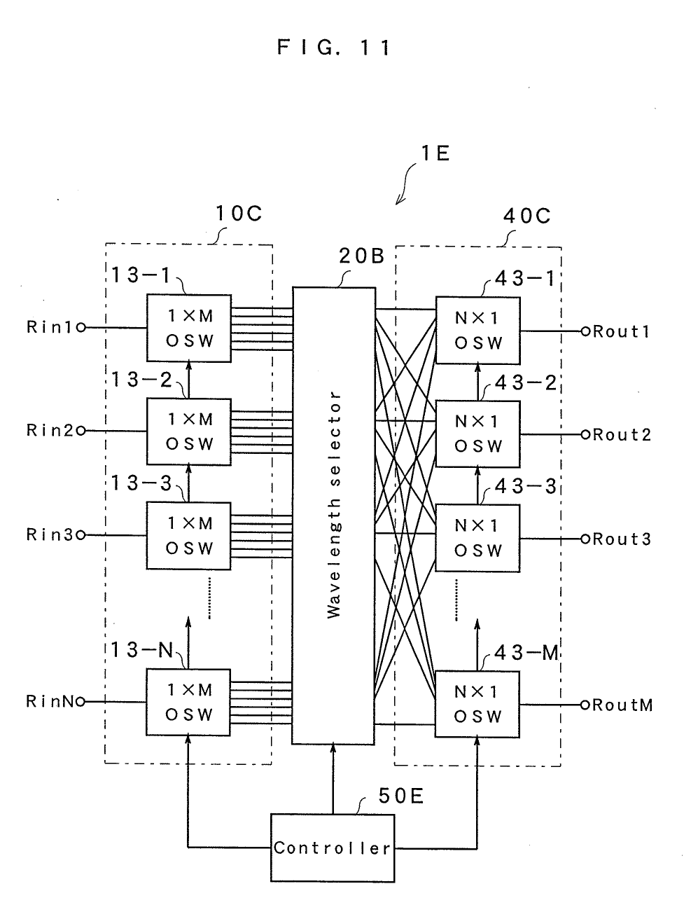

Next, a third embodiment of the present invention will be described. FIG. 9 is a diagram showing a configuration of a wavelength selective light cross connect device 1C in accordance with the third embodiment of the present invention. In this embodiment, a plurality of route selection elements in a route selector 100 each are formed of an optical switch. That is, the route selector 100 uses N (1×M) optical switches (OSW) 13-1 to 13-N as the route selection elements in place of splitters. The optical switch 13-1 selects a WDM optical signal of a first channel and outputs the selected signal from any of M output terminals to the wavelength selector 20B. The optical switch 13-2 selects a WDM optical signal of a second channel and outputs the selected signal from any of M output terminals to the wavelength selector 20B. The same applies to the other optical switches 13-3 to 13-N. The other configuration is almost the same as that in the second embodiment, and outputs of the optical switches are fed to the wavelength selector 20B, and outputs of the wavelength selector 20B are outputted to the couplers 42-1 to 42-M of the route selector 40B. A controller 50C controls wavelength selection of the wavelength selector 20B as well as switching states of the optical switches 13-1 to 13-N.

In this case, since the number of input routes capable of selecting one output route is N, signals of different wavelength bands from the plurality of input routes can be combined and outputted as one output WDM signal. Further, an optical signal of desired wavelength as an output of each output route can be selected from all of the input routes Rin1 to RinN. In this case, since the optical switches are provided in the route selector 100 on the side of the input routes, optical loss is small. However, when one output route selects the WDM optical signals from all of the input routes, no optical signal is outputted from the other output routes. In other words, the multi-cast function to output the WDM signal inputted to one input route to the plurality of output routes cannot be performed.

### Fourth Embodiment

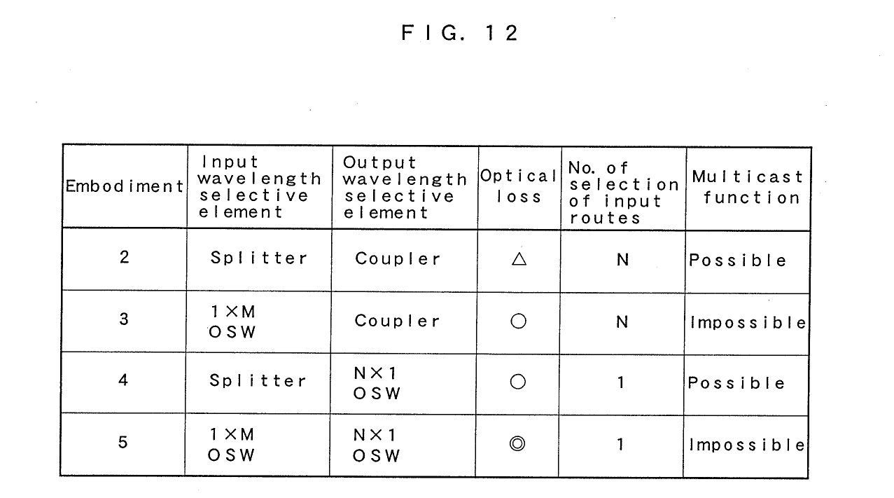

Next, a fourth embodiment of the present invention will be described. FIG. 10 is a diagram showing a configuration of a wavelength selective light cross connect device 1D in accordance with the fourth embodiment of the present invention. In this embodiment, in a wavelength selector 40C on an output side, M (N×1) optical switches (OSW) 43-1 to 43-M in place of the couplers 42-1 to 42-M are used as route selection elements. The other configuration is similar to that in the second embodiment, and on the side of the input routes, the splitters 12-1 to 12-N in the route selector 10B are used, and each splitter outputs M outputs to the wavelength selector 20B. The optical switch 43-1 receives first outputs of the splitters 12-1 to 12-N, which pass through the wavelength selector 20B, selects one of them and outputs the selected output to the output route Rout1 as one WDM signal. The optical switch 43-2 receives second outputs of the splitters 12-1 to 12-N, which pass through the wavelength selector 20B, selects one of them and outputs the selected output to the output route Rout2 as one WDM signal. The same applies to the other optical switches 43-3 to 43-M. A controller 50D controls wavelength selection of the wavelength selector 20B and switching states of the optical switches 43-1 to 43-N.

In this case, since the route selection elements on an output side are optical switches, the number of input routes that can be selected from one output route is one. However, since the splitters 12-1 to 12-N are provided on an input side, a multi-cast function to output the WDM light signal inputted to one input route to the plurality of output routes can be performed. Further, since the route selection elements on the output side are optical switches, optical loss is small.

### Fifth Embodiment

Next, a fifth embodiment of the present invention will be described. FIG. 11 is a diagram showing a configuration of a wavelength selective light cross connect device 1E in accordance with the fifth embodiment of the present invention. In this embodiment, elements in the route selector 100 on an input side are formed of the optical switches 13-1 to 13-N, and elements in the route selector 40C on an output side are formed of the optical switches 43-1 to 43-M. A controller 50E controls wavelength selection of the wavelength selector 20B as well as switching states of the optical switches 13-1 to 13-N and 43-1 to 32-M.

In this case, signals of different wavelength from the plurality of input routes cannot be outputted as an output of one output route. Further, the WDM signal from one input route cannot be outputted from the plurality of output routes. However, since the optical switches are used, the wavelength of the WDM signal from each input route can be filtered on wavelength basis, thereby minimizing optical loss.

FIG. 12 shows configurations of the route selectors in the cross connect devices in accordance with second to fifth embodiments and their functions. Here, the input route selection number denotes the number of input routes that can be selected by one output route.

### Sixth Embodiment

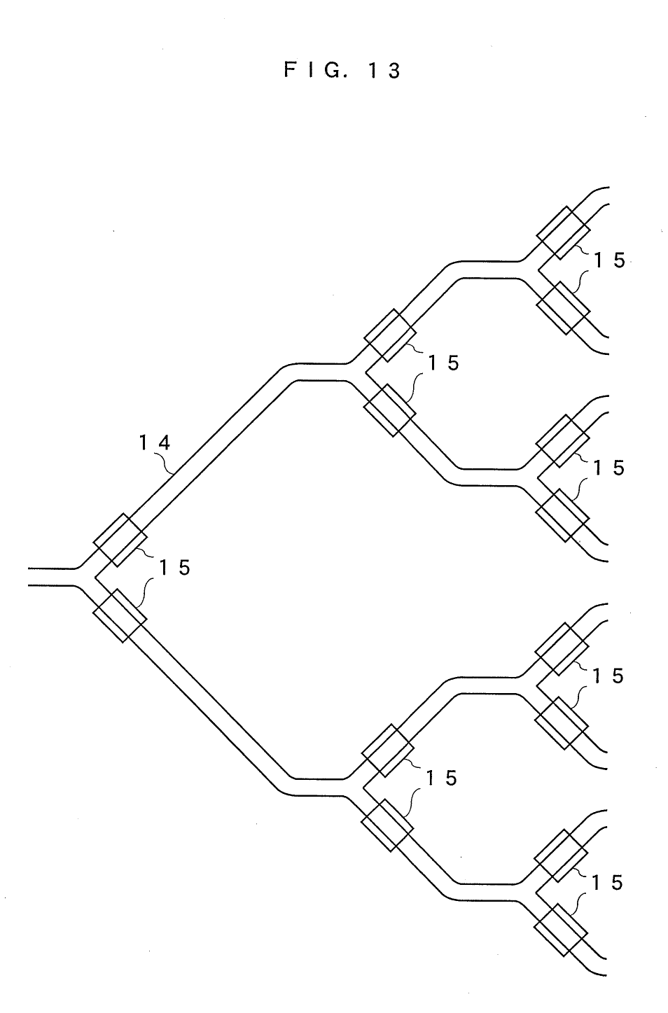

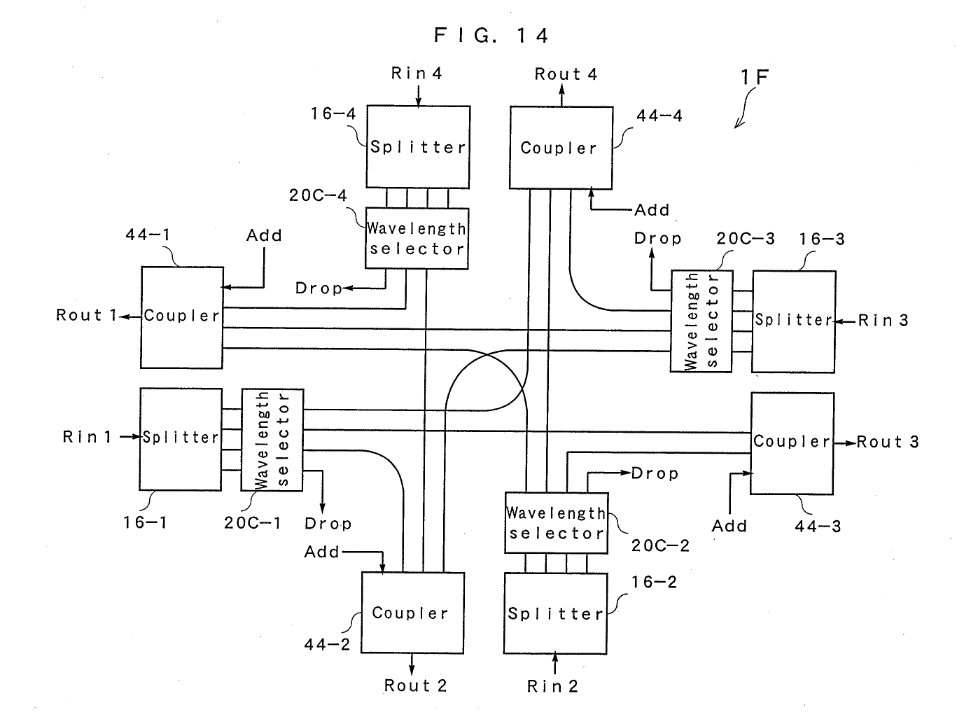

Next, a sixth embodiment of the present invention will be described. In this embodiment, as shown in FIG. 13, in place of an optical switch, a splitter or a coupler, a Y-shaped branch circuit formed on an optical waveguide 14 is used as a route selection element, and heating layers 15 are superimposed on branch points to selectively control a current applied to the heating layers, so that the functions of the splitter, coupler or optical switch can be controlled from the outside. Because the other configuration is the same as that in the first embodiment, detailed description thereof is omitted.

For example, in a configuration shown in FIG. 13, the Y-shaped branch is combined to one input route in a tree-shaped structure to form eight outputs. An equally divided voltage may be outputted to each output terminal by applying a voltage of a level that permits branch to the heating layers at each branch, or a WDM signal inputted from an input terminal may be outputted to any of output terminals as it is. A directional coupler may be used in place of the Y-shaped branch. In this case, the directional coupler can be also used as a switch or splitter, and any of functions can be performed by controlling these functions. For the route selection elements on an output side, one input can be selected by inverting input/output relation, or the inputs can be superimposed with each other as they are to form one output. By forming each route selection element on the optical waveguide in this manner, functions in second to fifth embodiments can be switched. Since this embodiment is configured by use of the optical waveguide, a failure rate is low, compact mounting area is achieved and the transmission reliability is improved.

### Seventh Embodiment

Next, a seventh embodiment of the present invention will be described. FIG. 14 is a diagram showing a configuration of a wavelength selective light cross connect device 1F in accordance with the seventh embodiment of the present invention. In this embodiment, an add drop function is added to the above-mentioned wavelength selective light cross connect device in accordance with the second embodiment to configure a cross connect device 1F having four inputs and four outputs (N=M=4). In this embodiment, route selectors on an input side are formed of four splitters 16-1 to 16-4. Wavelength selectors are formed of four wavelength selectors 20C-1 to 20C-4 having four inputs and four outputs. Route selectors on an output side are formed of four couplers 44-1 to 44-4.

In this figure, the splitters 16-1 to 16-4 are connected to the input route Rin1 to Rin4, respectively. The splitter 16-1 divides an input signal into four WDM signals, and feeds the WDM signals to the wavelength selector 20C-1. The other splitters 16-2 to 16-4 divide an input signal into four WDM signals, and feed the WDM signals to the wavelength selectors 20C-2 to 20C-4, respectively. Like the above-mentioned wavelength selectors, the wavelength selector 20C-1 separates four inputs according to their wavelengths and performs a filtering operation. A first input obtained from the splitter 16-1 is subjected to the filtering operation and becomes a drop output. Second to fourth inputs are outputted to the three couplers 44-2 to 44-4 of channels which are different from the same input/output channel, respectively. The same applies to the other wavelength selectors 20C-2 to 20C-4. In FIG. 14, a controller for controlling the wavelength selector 20C-1 to 20C-4 is not shown.

The coupler 44-1 synthesizes one output of each of the three wavelength selectors 20C-2, 20C-3, 20C-4 and an optical signal of a certain wavelength inputted from an add terminal, and outputs the synthesized signal from an output terminal Rout1. The coupler 44-2 synthesizes one output of each of the three wavelength selectors 20C-1, 20C-3, 20C-4 and an optical signal of a certain wavelength inputted from one add terminal, and outputs the synthesized signal from an output terminal Rout2. The coupler 44-3 synthesizes one output of each of the three wavelength selectors 20C-1, 20C-2, 20C-4 and an optical signal of a certain wavelength inputted from an add terminal, and outputs the synthesized signal from an output terminal Rout3. The coupler 44-4 synthesizes one output of each of the three wavelength selectors 20C-1, 20C-2, 20C-3 and an optical signal of a certain wavelength inputted from an add terminal, and outputs the synthesized signal from an output terminal Rout4. In this manner, the add drop function is added to the optical cross connect device to realize an RODAM device.

Although the wavelength selectors are formed of the four wavelength selector 20C-1 to 20C-4 having four inputs and four outputs, one wavelength selector having 16 inputs and 16 outputs may be employed.

### Eighth Embodiment

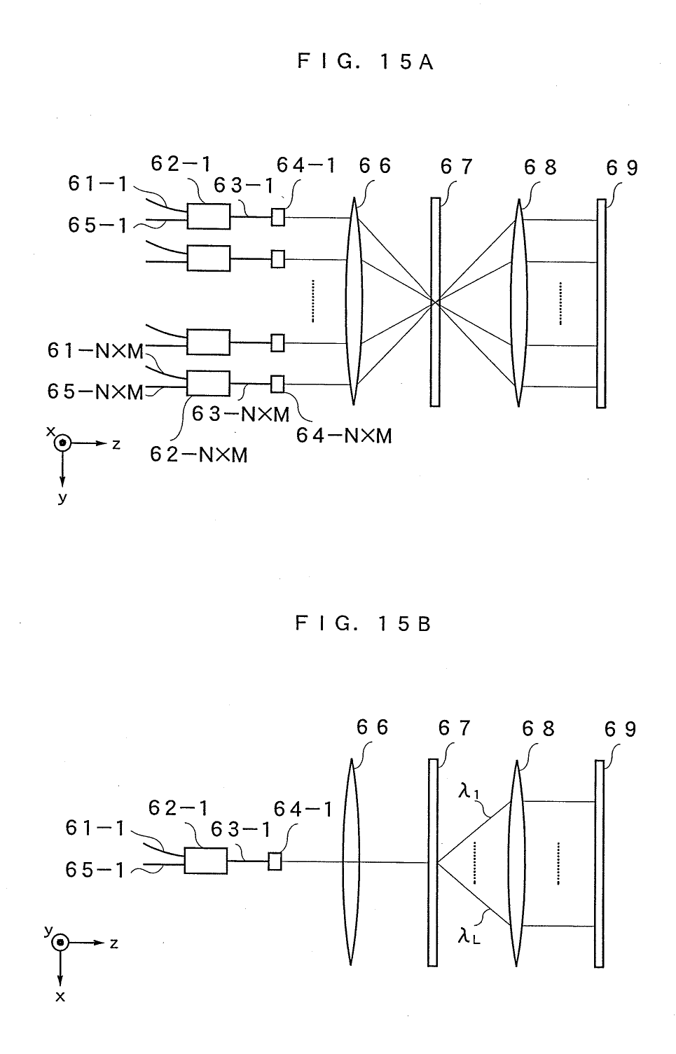

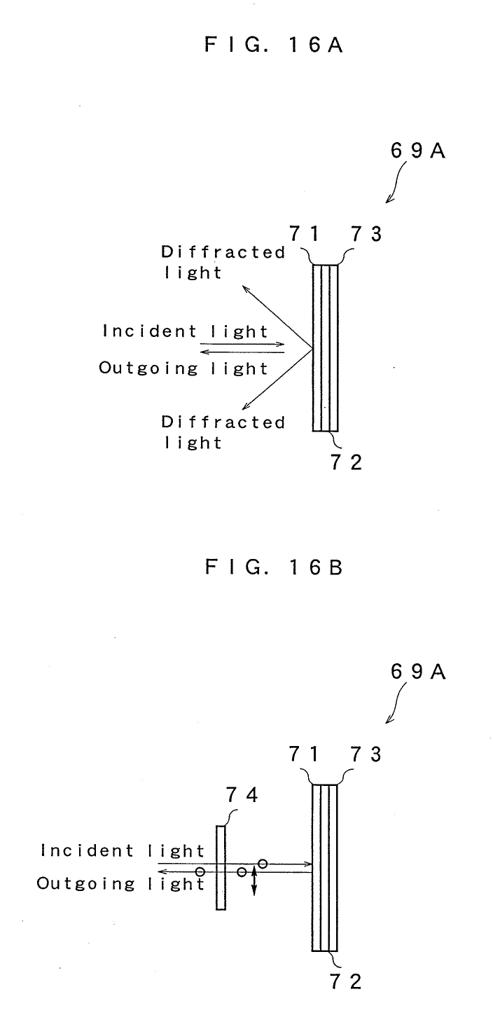

Although the transmission-type wavelength selector using LCOS is used as the wavelength selector in second to seventh embodiments, a reflection-type wavelength selector 20D may be employed. FIG. 15A is a side view showing an optical element of the reflection-type wavelength selector 20D as seen in an x-axis direction, and FIG. 15B is a side view showing the optical element of the reflection-type wavelength selector as seen in a y-axis direction. Incoming light beams are N×M WDM signal light beams, and each WDM light beam results from multiplexing of optical signals ranging in wavelength from λ₁ to λ_{L}. Each WDM light beam is fed to circulators 62-1 to 62-(N×M) via optical fibers 61-1 to 61-(N×M). The incoming light beams may be either inputted to the circulators 62-1 to 62-(N×M) via the optical fibers 61-1 to 61-(N×M), or inputted directly to the circulators. The circulators 62-1 to 62-(N×M) allow the incoming light beams to exit to collimator lenses 64-1 to 64-(N×M) via optical fibers 63-1 to 63-(N×M), respectively, and also allow light beams incident on the optical fibers 63-1 to 63-(N×M) to exit to optical fibers 65-1 to 65-(N×M), respectively. Further, the light beams exited from the collimator lenses 64-1 to 64-(N×M) via the optical fibers 63-1 to 63-(N×M) are parallel to each other in a direction of a z axis. The WDM light beams of all channels are condensed into a spot at a focal point by a lens 66 to enter a wavelength dispersion element 67 placed at the light condensing position. The wavelength dispersion element 67 acts to disperse light in different directions relative to the x-axis direction according to wavelength. Here, the wavelength dispersion element 67 may be formed of a transmission-type or reflection-type diffraction grating or a prism or the like, or a combination of the diffraction grating and prism. The dispersed light beams from the wavelength dispersion element 67 are fed to a lens 68. The lens 68 is a light condensing element for condensing light beams dispersed on an xz plane in a direction parallel to the z axis. The condensed light is incident perpendicular on a wavelength selection element 69.

It is noted that, in FIG. 15B, there are shown light having the shortest wavelength λ₁ and light having the longest wavelength λ_{L} by way of example. However, since incoming light is actually WDM signal light having a lot of spectra in a range from the wavelength λ₁ to the wavelength λ_{L}, the N×M WDM signal light beams developed over the xz plane are directed to the wavelength selection element 69 in a strip-like form. The wavelength selection element 69 selectively reflects incoming light, and selection characteristics of the optical filter are determined based on the reflection characteristics of the wavelength selection element 69. The light beams reflected from the wavelength selection element 69 pass through the same path to enter a lens 68, and are directed to the wavelength dispersion element 67 again. In the wavelength dispersion element 67, the reflected light beams are condensed in the same direction as the condensing direction of the original incoming light beams, and the condensed light is incident on the lens 66. The lens 66 turns the light into light beams parallel to the z-axis direction in the same path as that taken by the incoming light, and the light beams exit to the optical fibers 63-1 to 63-(N×M) via the collimator lenses 64-1 to 64-(N×M), respectively. The light beams are outputted to the optical fibers 65-1 to 65-(N×M) by the circulators 62-1 to 62-(N×M), respectively. Here, the optical fibers 61-1 to 61-(N×M), 63-1 to 63-(N×M), 65-1 to 65-(N×M), circulators 62-1 to 62-(N×M), collimator lenses 64-1 to 64-(N×M) and lens 66 constitute entrance/exit section for receiving the N×M WDM signal light beams and allowing exit of selected light. It is noted that the circulators 62-1 to 62-(N×M) are not necessarily fiber-type. When using spatial-type circulators, it is no need to provide the optical fibers 63-1 to 63-(N×M).

Next, the wavelength selection element 69 used in the reflection-type wavelength selector 20D can be configured of a reflection-type LCOS element. A reflection-type LCOS element 69A has a built-in liquid crystal modulation driver located at the back of each pixel. Accordingly, the number of pixels can be increased. In the LCOS element 69A, since light beams are incident separately at different positions according to WDM signal and wavelength, by bringing a pixel corresponding to the incident position of a target light beam into a reflective state, it is possible to select the optical signal thereof.

In the LCOS element 69A, a plurality of pixels can be assigned to each wavelength band of a single channel of a WDM signal same as the LCOS element 25A, it is possible to control filter characteristics as shown in FIGS. 7 and 8.

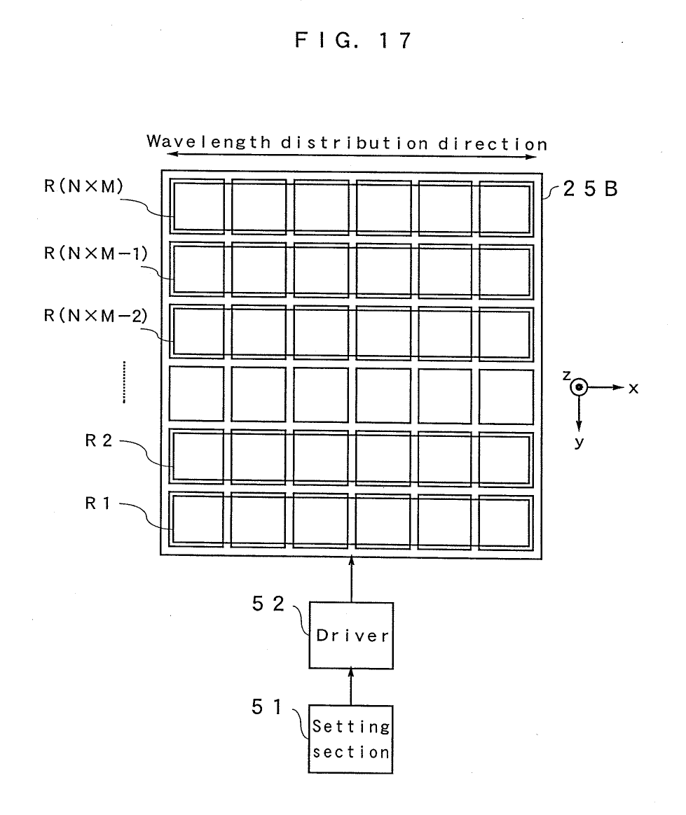

Now, as one of modulation modes applicable to the LCOS element 69A, a phase modulation mode will be explained. FIG. 16A is a schematic diagram showing the LCOS element 69A. The LCOS element 69A is composed of a transparent electrode 71, a liquid crystal 72, and a back reflection electrode 73 that are arranged in the order named, from the plane of incidence's side, along the z-axis direction in a layered structure. In the LCOS element 69A, since a plurality of pixels are assigned to constitute a single wavelength band of a single channel, it is possible to impart unevenness to a refractive index profile with respect to a plurality of pixels and thereby develop a diffraction phenomenon. Accordingly, by applying a voltage between the transparent electrode 71 and the back reflection electrode 73, the angles of diffraction of different frequency components can be controlled independently, so that input light with a specific wavelength can be simply reflected in the incident direction, and light of another wavelength components can be diffracted as unnecessary light and reflected in a direction different from the incident direction. Therefore, by controlling a voltage to be applied to each pixel, necessary pixels can be brought into a regularly-reflective state without causing diffraction.

Next, as another modulation mode applicable to the LCOS element 79A, an intensity modulation mode will be explained. FIG. 16B is a diagram showing a wavelength selection method based on the intensity modulation mode. A polarizer 74 is placed on the plane of incidence for incoming light and outgoing light as well. The polarizer 74 brings incoming light into a specific polarized state as indicated by an circle in the diagram, and the polarized light is incident on the LCOS element 69A of reflection type. Also in this case, the LCOS element 69A is composed of a transparent electrode 71, a liquid crystal 72, and a back reflection electrode 73. With the incidence of light on the LCOS element 69A, a difference in index of double refraction in the liquid crystal between the electrodes can be controlled on the basis of the conditions of voltage application. Accordingly, the polarization state of reflected light can be varied by adjusting to-be-applied voltages independently. Then, it is determined whether the plane of polarization is rotated or retained at the time of voltage control in accordance with orientational ordering among liquid-crystal molecular components. For example, assuming that the plane of polarization is retained in the absence of voltage application, then the light indicated by the circle is simply reflected. On the other hand, in the presence of voltage application, the plane of polarization is rotated to effect reflection, and the reflected light is shielded by the polarizer 74. Therefore the selection of incoming light can be achieved by controlling voltages to be applied to the pixels. The selection of a plurality of given wavelength bands of a plurality of given WDM signal light beams can be made by bringing a given number of corresponding pixels into a reflective state.

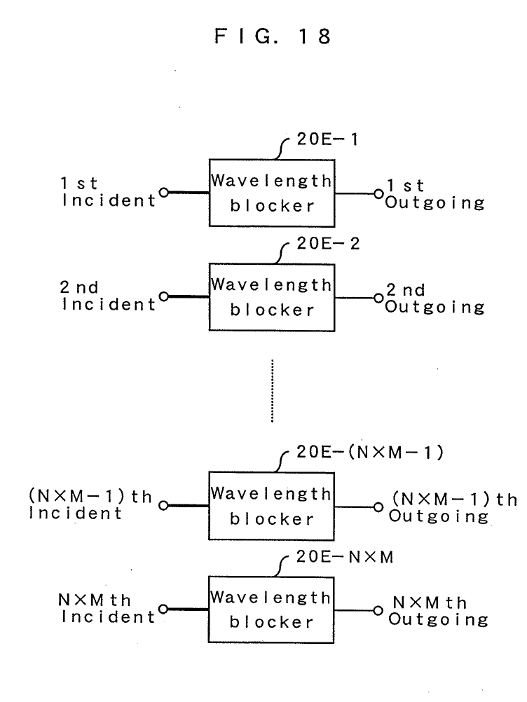

Although an LCOS element 25A is employed as the wavelength selection element 25 of the wavelength selector in first to seventh embodiments, a liquid crystal element 25B having a 2D electrode array instead of an LCOS structure can be used. In the LCOS element, a liquid crystal driver located at a back of each pixel is incorporated. On the other hand, in the 2D-electrode array light crystal element 25B, a driver 52 for liquid crystal modulation is disposed externally of the element. This makes it difficult to provide as many pixels as provided in the LCOS element. Accordingly, as in the case of FIG. 17, it is desired to adopt an L×M×N pixel arrangement in conformity with a two-dimensional L×N×M development of L wavelengths ranging from λ₁ to λ_{L} of N×M incoming WDM signals. In this case, although the filter configuration cannot be changed, desired plural wavelength bands can be selected from one incoming WDM signal. Further, in this case, only the above-mentioned intensity modulation method can be implemented. Moreover, a transmission level can be varied by changing a level of voltages applied to the pixels. A reflection-type liquid crystal element having 2D electrode array may be employed instead of the reflection-type LCOS element 69A used in an eighth embodiment.

Although the LCOS wavelength selection element 25A or wavelength selection element 69A is used as the wavelength selector in second to eighth embodiments, as shown in FIG. 18, N×M wavelength blockers 20E-1 to 20E-(N×M) may be provided with respect to first to N×M^{th} inputs to constitute the wavelength selector. The wavelength blocker is an element capable of transmitting or blocking a WDM signal light of a desired wavelength. In this case, a level of wavelength band in which light is transmitted can be made uniform by detecting a signal level of each wavelength by use of a power monitor and controlling outputs.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese application No. 2010-164128 filed on Jul. 21, 2010 is hereby incorporated by reference.

What is claimed is:

1. A wavelength selective light cross connect device for inputting wavelength division multiplexing optical signals (hereinafter referred to as WDM signals) of first to Nth channels, the signals each having wavelengths λ₁ to λ_{L} (L is a natural number of 2 or more), to N input routes (N is a natural number of 2 or more) respectively, selecting signals of desired plural wavelength from each of the inputted WDM signals and outputting the selected signals from M output routes (M is t a natural number of 2 or more) comprising:
a first group of N route selection elements each having one input terminal and M output terminals, the first group of route selection elements selecting at last one route for the WDM signal inputted to each input route and outputting the signal from the M output terminal;
a wavelength selector for receiving N×M outputs of said N route selection elements, selecting at last one optical signal of desired wavelengths from each of the inputted WDM signals and outputting the WDM signals of the same number as that of the inputted WDM signals; and
a second group of M route selection elements each having N input terminals and one output terminal, the second group of route selection elements selecting a route for the M WDM signals inputted to each input route and outputting the signal from the one output terminal.

2. The wavelength selective light cross connect device according to claim 1, wherein
said first group of route selection elements are N splitters for branching the inputted WDM signal into M outputs, and
said second group of route selection elements are M couplers for receiving one of outputs of each of said first group of route selection elements, the outputs passing through said wavelength selector, and synthesizing the outputs into one output.

3. The wavelength selective light cross connect device according to claim 1, wherein
said first group of route selection elements are N (1×M) optical switches for selectively directing the inputted WDM signal to one of M outputs, and
said second group of route selection elements are M couplers for receiving one of outputs of each of said first group of route selection elements, the outputs passing through said wavelength selector, and synthesizing the outputs into one output.

4. The wavelength selective light cross connect device according to claim 1, wherein
said first group of route selection elements are N splitters for branching the inputted WDM signal into M outputs, and
said second group of route selection elements are M (N×1) optical switches for receiving one of outputs of each of said first group of route selection elements, the outputs passing through said wavelength selector, and selecting one output.

5. The wavelength selective light cross connect device according to claim 1, wherein
said first group of route selection elements are N (1×M) optical switches for selectively directing the inputted WDM signal to one of M outputs, and
said second group of route selection elements are M (N×1) optical switches for receiving one of outputs of each of said first group of route selection elements, the outputs passing through said wavelength selector, and selecting one output.

6. The wavelength selective light cross connect device according to claim 1, wherein
each of said first group of route selection elements is a waveguide element for selecting at least one output by a branch cascade-connected on an optical waveguide, and
each of said second group of route selection elements is a waveguide element for selecting at least one input by the branch cascade-connected on the optical waveguide.

7. The wavelength selective light cross connect device according to claim 1, wherein
said first group of route selection elements are N splitters for branching the inputted WDM signal into M outputs,
said wavelength selector outputs at least a part of outputs of inputs obtained from each of said first group of route selection elements after a wavelength selective operation as a drop, and
said second group of route selection elements are M couplers, at least a part of inputs of said second group of route selection elements being an add input and remaining inputs being outputs of each of said first group of route selection elements, the outputs passing through said wavelength selector, the M couplers synthesizing these inputs into one output.

8. The wavelength selective light cross connect device according to claim 1, wherein
said wavelength selector includes:
a first dispersion element arranged along a direction of a y axis, the element spatially dispersing first to (N×M)^{th} WDM signal light beams having a plurality of wavelengths according to their wavelengths;
a first light condensing element for condensing the WDM light beam of each channel dispersed by said first dispersion element into parallel light beam;
a wavelength selection element having a multiplicity of pixels arranged in a direction of an x axis according to wavelength, the pixels being placed so as to receive N×M WDM light beams arranged at different positions with respect to the y axis so as to be developed over an xy plane and being arranged in a lattice pattern on the xy plane, and selecting light in desired wavelength bands with respect to desired WDM signals by changing transmission characteristics of each of the pixels arranged in a two-dimensional fashion;
a wavelength selection element driving unit for driving electrodes arranged in xy directions of said wavelength selection element to control light transmission characteristics of a pixel lying at a predetermined position in the x-axis direction as well as in the y-axis direction;
a second light condensing element for condensing light beams of different wavelengths transmitted through said wavelength selection element; and
a second wavelength dispersion element for synthesizing dispersed light beams condensed by said second light condensing element.

9. The wavelength selective light cross connect device according to claim 8, wherein
said wavelength selection element is an LCOS element.

10. The wavelength selective light cross connect device according to claim 8, wherein
said wavelength selection element is a two-dimensional liquid crystal array element.

11. The multiple input/output wavelength selective switch device according to claim 1, wherein
said wavelength selector includes:
a plurality of entrance/exit section arranged along a direction of a y axis, the entrance/exit section receiving first to (N×M)th WDM signal light beams, each of which is composed of multiple-wavelength light, and exiting optical signals of selected wavelengths on a channel to channel basis;
a wavelength dispersion element for spatially dispersing the (N×M) WDM signal light beams obtained from said entrance/exit section according to their wavelengths;
a light condensing element for condensing the WDM signal light beams of different channels dispersed by said wavelength dispersion element on a two-dimensional xy plane;
a wavelength selection element having a multiplicity of pixels arranged in a direction of an x axis according to wavelength, the pixels being placed so as to receive (N×M) WDM light beams arranged at different positions with respect to the y axis so as to be developed over the xy plane and being arranged in a lattice pattern on the xy plane, and the wavelength selection element selecting light in desired wavelength bands with respect to desired WDM signals by changing reflection characteristics of each of the pixels arranged in a two-dimensional fashion; and
a wavelength selection element driving unit for driving an electrode of each of the pixels arranged in xy directions of said wavelength selection element to control light reflection characteristics of a pixel lying at a predetermined position in the x-axis direction as well as in the y-axis direction.

12. The wavelength selective light cross connect device according to claim 11, wherein
said wavelength selection element is an LCOS element.

13. The wavelength selective light cross connect device according to claim 11, wherein
said wavelength selection element is a two-dimensional liquid crystal array element.

14. The wavelength selective light cross connect device according to claim 1, wherein
said wavelength selector is a wavelength blocker.
